(19) United States
(12) Patent Application Publication
(10) Pub. No.: US 2026/0220136 A1
(43) Pub. Date: Jul. 30, 2026

(54) METHOD AND SYSTEM FOR ORCHESTRATING ARTIFICIAL INTELLIGENCE (AI) AGENTS USING AN AGENTIC AI PLATFORM

(71) Applicant: LTI Mindtree Ltd, Mumbai (IN)

(72) Inventors: Brijesh Prabhakar, Mumbai (IN); ChandiPrasad Ojha, Mumbai (IN); Meena Malu, Mumbai (IN); Aarya Karambelkar, Mumbai (IN)

(21) Appl. No.: 19/234,588

(22) Filed: Jun. 11, 2025

(30) Foreign Application Priority Data
Jan. 28, 2025 (IN) 202521006969

(51) Int. Cl. G06F 16/2453; G06F 16/242

(52) U.S. Cl. CPC G06F 16/24542; G06F 16/243

(57) ABSTRACT

The present disclosure provides a method and system for orchestrating AI agents using an agentic AI platform, which includes a framework repository with a plurality of orchestration frameworks, and an agent repository with a plurality of AI agents. Each agent of the plurality of AI agents performs specialized tasks. A user query is processed to generate a structured representation and is decomposed into multiple task-segments. Multiple sub-tasks for each task-segment are identified and a task processing pattern for each sub-task is determined by analyzing task dependencies and execution flow. An AI agent is identified for performing each sub-task, and an orchestration framework is selected from the framework repository is selected based on parameters comprising the task processing pattern and characteristics of each sub-task. The orchestration framework is initiated, and each sub-task is executed using the AI agent through the orchestration framework.

### FIELD

Various embodiments of the present disclosure generally relate to agentic Artificial Intelligence (AI). More particularly, the disclosure relates to a method and system for orchestrating AI agents using an agentic AI platform that dynamically integrates capabilities from multiple agentic AI frameworks.

### BACKGROUND

Agentic AI are advanced AI systems that are capable of autonomous decision-making and action in complex environments. The platforms are designed to simulate human-like agency, where the AI can perceive its surroundings, process information, and take actions towards achieving predefined goals without requiring constant human intervention. The systems are increasingly applied in industries such as healthcare, finance, logistics, and customer service, where they can autonomously execute tasks, make real-time decisions, and interact with users or other systems to optimize operations and deliver personalized solutions.

In the field of Agentic AI development, a primary challenge lies in the rigid dependency on specific frameworks and tools that are often deeply integrated into proprietary ecosystems. The systems require developers to commit to a single set of platforms, programming languages, or methodologies, which significantly restricts the flexibility and adaptability of AI models. As a result, developers are often confined to using predefined approaches and solutions, limiting the ability to customize or scale the AI’s capabilities across different environments or industries.

Additionally, creation of autonomous agents with sophisticated workflows presents a significant challenge due to the substantial time, technical expertise, and resources required for development. Building the systems involves not only designing complex algorithms but also integrating various components, such as data processing, decision-making modules, and user interaction interfaces, so that the agent can operate autonomously across a range of environments. The process often necessitates specialized knowledge in multiple domains, including machine learning, natural language processing, and systems integration, further compounding the difficulty. Moreover, as the scope of autonomous agents expands, there is a growing need to ensure these systems comply with regulations like the General Data Protection Regulation (GDPR) and adhere to ethical guidelines. This is crucial to avoid the risks of bias in AI decision-making and ensure that user data is protected and handled responsibly.

Existing market solutions for Agentic AI development primarily offer framework-specific tools that cater to a narrow set of functionalities, focusing on basic automation, agent creation, and workflow management. The tools enable developers to build and deploy agents that can perform predefined tasks with a degree of autonomy, but they often lack the flexibility required for more advanced or cross-platform applications. Some popular frameworks extend their capabilities by offering limited cognitive functions, such as memory, perception, and action planning, which are essential for enabling agents to understand and adapt to their environment. However, these cognitive capabilities are generally rudimentary and may not provide the depth of reasoning and decision-making required for complex real-world scenarios.

Additionally, certain providers offer low-code or no-code features, making it easier for non-technical users to design and deploy agents. While these features contribute to the accessibility of agent development, they remain constrained within the specific capabilities and ecosystems of the respective frameworks, further limiting the overall adaptability and scalability of the agents. As a result, while these solutions offer valuable entry points for simple automation and agent-based tasks, they fall short in supporting more sophisticated, interoperable, and customizable Agentic AI systems that can meet the diverse needs of industries and environments.

Moreover, some of the existing tools face challenges in locking developers into a single agentic AI framework, limiting flexibility in leveraging the strengths of multiple frameworks, lacking advanced cognitive constructs such as dynamic memory management (both short-term and long-term), struggling to integrate data from diverse sources effectively, limited guardrails for PII, PCI, PHI, and ethical considerations resulting in risks to users.

Therefore, there is a need for a solution that can address the aforementioned challenges by enabling dynamic integration of capabilities from multiple agentic AI frameworks, and by enabling on-the-fly creation of AI agents and workflows with low-code/no-code flexibility.

### SUMMARY

The present disclosure provides a method and system for orchestrating AI agents using an agentic AI platform. The agentic AI platform includes a framework repository with a plurality of orchestration frameworks, and an agent repository with a plurality of AI agents. Each agent of the plurality of AI agents performs specialized tasks. A user query is processed to generate a structured representation using a natural language model, and is decomposed into multiple task-segments. Multiple sub-tasks for each task-segment are identified and a task processing pattern for each sub-task is determined by analyzing task dependencies and execution flow. The task processing pattern may include at least one of a sequential processing, a parallel processing, an iterative processing, and a graph-based processing.

An AI agent from the plurality of agents is identified for performing each sub-task, and an orchestration framework is selected from the framework repository is selected based on parameters comprising the task processing pattern and characteristics of each sub-task. The orchestration framework is initiated, and each sub-task is executed using the AI agent through the orchestration framework.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an environment within which various embodiments of the disclosure may function.

FIG. 2 is a diagram that illustrates a system for orchestrating AI agents using an agentic AI platform, in accordance with an embodiment of the disclosure.

FIG. 3 is a diagram that illustrates a flowchart with a method for orchestrating AI agents using an agentic AI platform, in accordance with an embodiment of the disclosure.

### DESCRIPTION

Pursuant to various embodiments, the present disclosure provides a method and system for orchestrating AI agents using an agentic AI platform. The agentic AI platform includes a framework repository with a plurality of orchestration frameworks, and an agent repository with a plurality of AI agents. Each agent of the plurality of AI agents performs specialized tasks. A user query is processed to generate a structured representation using a natural language model, and is decomposed into multiple task-segments. Multiple sub-tasks for each task-segment are identified and a task processing pattern for each sub-task is determined by analyzing task dependencies and execution flow. The task processing pattern may include at least one of a sequential processing, a parallel processing, an iterative processing, and a graph-based processing. An AI agent from the plurality of agents is identified for performing each sub-task, and an orchestration framework is selected from the framework repository is selected based on parameters comprising the task processing pattern and characteristics of each sub-task. The orchestration framework is initiated, and each sub-task is executed using the AI agent through the orchestration framework.

In one or more embodiments, AI agents refer to autonomous entities that operate within a system to achieve predefined objectives through decision-making, learning, and interaction. The AI agents are typically designed to process data, execute tasks, and adapt their behavior in response to changes in their environment or input parameters. AI agents may be task-specific, such as performing data analysis or customer support, or they may collaborate with other agents to solve complex problems in a distributed manner.

In one or more embodiments, the agentic AI platform refers to a system comprising multiple interconnected AI agents that collaboratively operate to execute complex tasks and deliver solutions. The agentic AI platform is designed to provide a cohesive environment where autonomous agents, each specialized in distinct functionalities, communicate and coordinate to achieve shared objectives. The agentic AI platform facilitates integration of diverse agents for efficient handling of tasks across various application domains.

In one or more embodiments, the agentic AI platform also refers to a system comprising a framework repository with a plurality of orchestration frameworks, each designed to enable coordination and interaction among multiple AI agents. The orchestration frameworks provide predefined protocols, rules, and workflows that facilitate efficient communication, task allocation, and data sharing among the agents. The framework repository enables the platform to dynamically select and apply the most appropriate orchestration framework based on the specific requirements of a task or operational context.

In one or more embodiments, the tasks in the context of present disclosure refers to specific operations, processes, or objectives that the AI agents within the agentic AI platform are configured to perform. The tasks may include, but are not limited to, data processing, analysis, decision-making, information retrieval, predictive modeling, and real-time interaction with users or other systems. The tasks can range from simple, repetitive operations to complex, multi-faceted activities that require coordination among multiple AI agents.

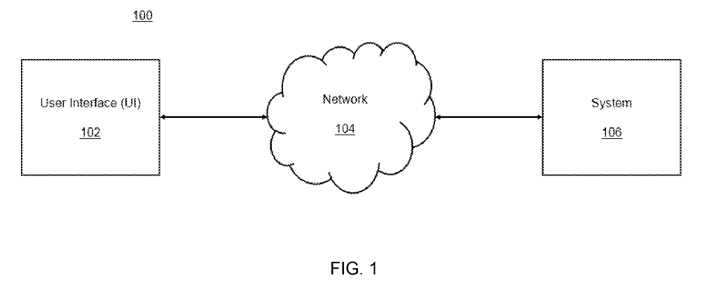

FIG. 1 is a diagram that illustrates an environment 100 within which various embodiments of the disclosure may function. Referring to FIG. 1, the environment 100 comprises a user interface (UI) 102, a network 104, and a system 106.

The UI 102 may comprise suitable logic, code, and/or interfaces that may be configured to receive user queries. The UI 102 may be configured to receive the user queries in one or more formats such as, text, voice, or structured input (e.g., forms or dropdown menus). Additionally, the UI 102 may support multiple modes of interaction, including natural language queries, predefined commands, or query selections from a set of options.

In one or more embodiments, the user queries can be of different types such as, for instance, informational queries, decision-making queries, task execution requests, and contextual inquiries.

In one or more embodiments, the UI 102 is also configured to present the generated output to a user in response to the user query. The output is presented to the user in one or more formats such as text, graphical representations, charts, or visual summaries, depending on the nature of the query and the corresponding response.

The network 104 includes communication networks operable to facilitate communication, either wirelessly or wired. The network 104 connects a plurality of computer systems. The network 104 may comprise, for example, an intranet, local area network, wide area network, the internet, or other wireless networks.

The system 106 of the present disclosure provides an intuitive user experience by offering and recommending the most suitable framework for a given problem statement. Based on the nature of the business problem, the system 106 identifies and recommends a set of intelligent, autonomous agents from its agent repository. These AI agents utilize the full capabilities of the agentic AI framework, adapting to the detected tasks and leveraging domain-specific knowledge through integrated APIs and tools. The orchestration of these agents occurs within a workflow that supports low-code or no-code capabilities, enabling users to efficiently manage and customize the system's 106 operation without requiring extensive programming expertise.

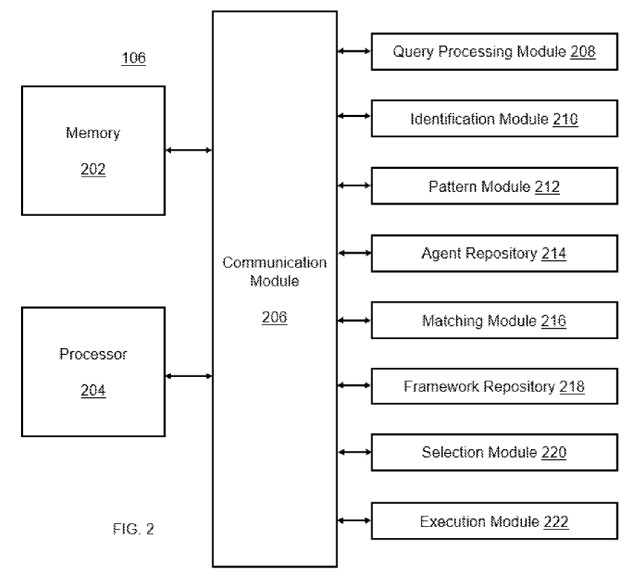

FIG. 2 is a diagram that illustrates the system 106 for orchestrating AI agents, in accordance with an embodiments of the disclosure. Referring to FIG. 2, the system 106 comprises a memory 202, a processor 204, a communication module 206, a query processing module 208, an identification module 210, a pattern module 212, an agent repository 214, a matching module 216, a framework repository 218, a selection module 220, and an execution module 222.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions store din the memory 202 to implement various functionalities of the system 106 in accordance with various aspects of the present disclosure. The communication module 206 is configured to facilitate seamless interaction between the processor 204 and various modules within the system 106.

Upon receiving the user query via the UI 102, the query processing module 208 incorporated with suitable logic, code, and/or interfaces, generates a structured representation of the query. The query processing module 208 utilizes a natural language model that is capable of understanding and interpreting the query for generating the structured representation.

In one or more embodiments, the query processing module 208 first analyzes the query to detect key components such as the intent, entities, and relationships within the user’s request, and converts the information into a structured format, such as a query template, that can be easily processed by the system 106.

In one or more embodiments, the structured representation of the query comprises task objectives and constraints. The task objectives define the goals or outcomes that the user intends to achieve through their query, such as retrieving specific data, making a decision, or performing a particular action. The constraints, on the other hand, specify limitations or conditions that must be adhered to while addressing the task, such as time frames, resource availability, or domain-specific rules.

In one or more embodiments, the query processing module 208 decomposes the structured representation of the query into at least one task segment using a Large Language Model (LLM). The LLM analyzes the structured query representation to break it down into smaller, more manageable components, each corresponding to a distinct task or sub-task. The task segments are defined based on the identified objectives and constraints, enabling the system 106 to handle complex, multi-step processes. The LLM understands the context and relationships within the query so that each segment accurately represents a portion of the user's intent.

In one or more embodiments, the user query received via the UI 102 may fall into multiple modules of a domain value stream, each representing a distinct part of the overall process or workflow. The decomposition of the query involves identifying the relevant domain value stream, determining which specific module within that stream is most applicable, and further breaking down the query into the appropriate segment within that module. The segmentation enables the system 106 to efficiently route the query to the right components, enabling each part of the value stream to handle the task according to its specific domain expertise.

The identification module 210 comprising suitable logic, code, and/or interfaces may be configured to identify at least one sub-task within the task segment. Upon receiving the task segment, the identification module 210 analyzes its content and context to break it down into smaller, more specific sub-tasks. The sub-tasks are typically more granular actions or objectives that contribute to fulfilling the task segment. The identification module 210 leverages domain knowledge, predefined rules, and contextual information for accurate identification of sub-tasks.

In some non-limiting embodiments, the domain knowledge refers to a repository of specialized information and expertise related to a specific field may include ontologies, taxonomies, terminologies, workflows, and best practices associated with the domain.

In some non-limiting embodiments, predefined rules consist of conditional logic and heuristics that guide the identification module 210 in breaking down task segments into sub-tasks. The predefined rules are derived from domain standards, operational guidelines, or user-defined parameters.

In some non-limiting embodiments, contextual information refers to the specific details surrounding the task segment, including user preferences, historical data, environmental conditions, and dependencies.

The pattern module 212 may comprise suitable logic, code, and/or interfaces that may be configured to determine a task processing pattern for the at least one sub-task by analyzing task dependencies and execution flow. Upon receiving the identified sub-task, the pattern module 212 examines the interdependencies between various sub-tasks, taking into account factors such as sequential, parallel, or conditional execution requirements. The pattern module 212 then analyzes the flow of execution, ensuring that the tasks are processed in an efficient order based on their dependencies, priority, and available resources.

In one or more embodiments, the pattern module 212 is configured to dynamically adapt the task processing pattern based on real-time conditions, such as resource availability or external events, which may affect the execution flow. The adaptability allows the system 106 to adjust its task processing approach in response to changing workloads, so that the task completion is efficient and aligned with the overall goals.

In one or more embodiments, the task processing pattern by the pattern module 212 involves at least one of a sequential processing, a parallel processing, an iterative processing, and a graph-based processing.

In one or more embodiments, in sequential processing, the sub-tasks are executed one after the other in a predefined order. The pattern is typically used when the execution of one sub-task is dependent on the output or completion of the previous sub-task. The pattern module 212 ensures that each sub-task is processed in the correct sequence, allowing the system 106 to maintain logical consistency and prevent errors due to premature execution.

In one or more embodiments, parallel processing involves the concurrent execution of multiple sub-tasks, enabling faster completion by utilizing multiple resources or processors simultaneously. The pattern is employed when the sub-tasks are independent of one another, meaning they can be executed in parallel without affecting the outcome of other tasks. The pattern module 212 identifies such independent sub-tasks and routes them for parallel execution, significantly improving efficiency and reducing overall processing time.

In one or more embodiments, iterative processing is used when sub-tasks need to be repeated multiple times with varying inputs or conditions. The pattern module 212 identifies the need for an iterative approach and determines the number of iterations required based on factors such as convergence criteria or predefined limits. Each iteration may involve the refinement of results, with outputs from previous iterations influencing the execution of subsequent ones.

In one or more embodiments, in graph-based processing, the task processing pattern is represented as a graph, where each node corresponds to a sub-task, and edges represent dependencies or execution flow between them. The pattern module analyzes the structure of the graph, identifying possible execution paths and optimizing the order of sub-task execution based on dependencies, constraints, and available resources.

The agent repository 214 may include suitable logic, code, and/or interfaces that is configured to store a plurality of AI agents, where each agent is specifically designed and trained to perform specialized tasks. The AI agents may be organized based on their capabilities, domains of expertise, and task-specific functionalities, allowing the system 106 to match them to the relevant queries or requirements.

In one or more embodiments, each agent in the agent repository 214 may be equipped with its own set of tools, algorithms, or APIs that are tailored to handle particular types of data processing, decision-making, analysis, or other specialized functions.

In one or more embodiments, AI agents refer to autonomous software entities that perform specialized tasks within the agentic AI platform. For example, an AI agent within the agent repository 214 may be designed to process user data and identify patterns related to customer behavior in an e-commerce environment. The "Customer Insights Agent" is configured to analyze customer interactions, purchase histories, and browsing behavior to provide recommendations for product placement or marketing strategies.

In another embodiment, an AI agent "Query Resolution Agent" may be responsible for handling user queries related to business processes, identifying relevant data sources, and presenting actionable insights. The AI agent uses natural language processing (NLP) capabilities to understand the user’s question, determine the intent, and retrieve the appropriate information from a database or other knowledge sources.

Additionally, in some embodiments, AI agents may be designed to collaborate and coordinate with one another to accomplish more complex tasks. For example, a "Data Collection Agent" may gather relevant data, which is then processed by a "Data Cleaning Agent" for further refinement before being passed to an "Analysis Agent" for insights extraction.

In some non-limiting embodiments, AI agents stored in the agent repository 214 can be specialized agents such as, for example, domain agents, planner agents, helper agents, language agents, task agents, knowledge agents, etc.

The matching module 216 may comprise suitable logic, code, and/or interfaces that may be configured to identify and match at least one AI agent of the plurality of AI agents from the agent repository 212, to perform the at least one sub-task. In cases where multiple sub-tasks are identified, the matching process by the matching module 216 is performed iteratively. Each sub-task is analyzed either sequentially or in parallel, by examining its objectives, constraints, and dependencies. The iterative analysis enables the matching module 216 to evaluate the specific requirements of each sub-task and compare them against the capabilities, specialties, and configurations of the available AI agents in the agent repository 214. By performing the iterative matching process, the system 106 selects the most appropriate AI for each sub-task, thereby optimizing task execution and ensuring alignment with the overall task processing pattern.

In one or more embodiments, the matching module 216 evaluates the functionality of each AI agent, determining which agent is best suited to handle the particular sub-task, which may involve matching domain expertise, computational capabilities, and available tools or APIs. For instance, if the sub-task involves natural language processing, the matching module 216 might select an AI agent specialized in NLP tasks. Similarly, if the sub-task requires data analysis or machine learning, the matching module 216 may match the appropriate AI agent with the necessary algorithms and data-processing tools.

The framework repository 218 may comprise suitable logic, code, and/or interfaces that may comprise a plurality of orchestration frameworks. Each orchestration framework is designed to handle different aspects of task coordination and agent interaction, providing the necessary structure and processes for integration and execution of tasks within the system 106.

In one or more embodiments, the orchestration frameworks within the framework repository 218 serve as pre-defined structures or templates that dictate how tasks and sub-tasks should be managed and executed across the AI agents. The orchestration frameworks may differ in their approach, based on the type of tasks being processed, the required resources, or the business logic governing the operations. For instance, some frameworks may be optimized for sequential task execution, while others may support parallel or iterative processing, depending on the complexity of the sub-tasks.

In an exemplary embodiment, an orchestration framework in the framework repository 218 may be configured for data processing tasks, managing the flow of data from collection through cleaning, transformation, and analysis. Another orchestration framework may be intended for managing business process workflows, coordinating actions between AI agents that handle customer support, inventory management, and order fulfillment.

In one or more embodiments, the framework repository 218 maintains metadata for each orchestration framework indicating supported task processing patterns. The metadata serves as a descriptor for the capabilities of each framework, enabling the system 106 to select the most suitable framework based on the nature of the tasks or sub-tasks to be processed. Specifically, the metadata includes attributes defining agentic framework interaction patterns, such as:

Planning Types (e.g., predictive, strategic, tactical, contingency) to specify the nature of task planning supported by the agentic framework.

Conversation Styles (e.g., Q&A, debate, brainstorming, round table discussion) to define how agents interact during task execution.

Decision Intelligence (e.g., voting, directive, analytical, behavioral, or agents autonomously deciding further actions) to characterize the decision-making mechanisms facilitated by the agentic framework.

Action Groups (e.g., reflection, command, reasoning, action chain, action tree, action graph) to detail the structure and flow of actions executed by the agents.

In one or more embodiments, by maintaining the metadata, the framework repository 218 allows the system 106 to make informed decisions when orchestrating tasks. When a user query is received and the tasks are decomposed into sub-tasks, the system 106 can reference the metadata to identify orchestration frameworks that align with the task processing patterns required by the sub-tasks.

In some non-limiting embodiments, the metadata may facilitate updates to orchestration frameworks. As new task processing patterns or optimizations are introduced, the metadata can be updated to reflect the changes.

The selection module 220 may comprise suitable logic, code, and/or interfaces that may be configured to select an orchestration framework from the plurality of orchestration frameworks of the framework repository 218.

In one or more embodiments, the selection module 220 analyzes the structured representation of the user query and the identified task processing patterns to determine the most suitable orchestration framework.

In one or more embodiments, the selection module 220 selects an orchestration framework based on parameters comprising the task processing pattern and characteristics of the at least one sub-task.

In one or more embodiments, the task processing pattern refers to the structural approach required for executing the sub-task, such as sequential processing, parallel processing, iterative processing, or graph-based processing. The selection module 220 evaluates the task dependencies, execution flow, and resource allocation needs to match the processing pattern with a compatible orchestration framework.

In one or more embodiments, the characteristics of the sub-task include attributes such as the sub-task’s complexity, data requirements, domain-specific considerations, execution priority from a functionality perspective, and resource consumption. Execution priority refers to the functional significance of the sub-task within the overall workflow, such as whether it acts as a prerequisite for subsequent tasks or directly impacts the task processing logic. For example, a data-intensive sub-task may require a framework that integrates robust data handling mechanisms, while a real-time processing sub-task may necessitate a framework optimized for low-latency operations.

In one or more embodiments, selecting the orchestration framework by the selection module 220 involves matching capabilities of each orchestration framework with the task requirements. The capabilities of each orchestration framework are derived from the metadata maintained within the framework repository 218. The metadata provides detailed descriptions of the frameworks, including their supported task processing patterns (e.g., sequential, parallel, iterative, graph-based), resource utilization efficiency, scalability, compatibility with AI agents, and domain-specific optimizations. The selection process emphasizes pattern detection at the task level for effective agent orchestration and considers the specific nature of the task. The nature of the task may include:

Iterative or feedback loop feature, where tasks require repeated refinement or cyclical evaluation;

Decision-making capability, to determine whether intelligent decisions are required at various stages;

Multi-modal capabilities, to handle tasks involving diverse data types or input formats;

Human intervention capability, to allow for manual oversight or input when needed;

Multi-agent collaboration patterns, to support complex interactions and coordinated execution among multiple agents.

The execution module 222 may comprise suitable logic, code, and/or interfaces that is configured to instantiate the selected orchestration framework from the framework repository 218 and facilitate its operation within the agentic AI platform. The instantiation process involves initializing the components of the selected framework, configuring its parameters based on the task requirements, and integrating it into the system’s 106 operational workflow.

In one or more embodiments, upon instantiating the selected orchestration framework, the execution module 222 executes the at least one sub-task by leveraging the capabilities of the at least one AI agent identified by the matching module 216. Each agent execution comprises three iterative steps such as, Observation, Action, and Reflection.

Observation may involve analyzing the sub-task context, including its objectives, current state, and any dependencies, to gather the necessary input for execution.

Action may refer to the execution of the sub-task by the agent, as defined by the orchestration framework and its task processing flow.

Reflection may involve evaluating the outcomes of the executed action, identifying changes in the task context, and generating observations for subsequent steps.

In an exemplary embodiment, if the selected orchestration framework supports parallel processing, the execution module 222 coordinates the simultaneous execution of multiple sub-tasks by distributing them across compatible AI agents. Alternatively, for sequential processing, the execution module 222 ensures that the sub-tasks are executed in the correct order, with the output of one serving as the input for the next. In the case of iterative processing, the execution module 222 manages repeated cycles of execution to refine results or meet specific task criteria.

In some non-limiting embodiments, the system 106 comprises an Application Programming Interface (API) gateway that acts as an interface between user requirements and the underlying AI ecosystem. The API gateway of the system 106 ensures privacy, security, and adherence to responsible AI guardrails.

In some non-limiting embodiments, the system 106 maintains a long-term memory (LTM) and a short-term memory (STM) of AI agent interactions to ensure consistency and context-awareness across tasks. The LTM serves as a repository for storing historical data and interaction patterns, enabling the system 106 to retain knowledge over extended periods and apply it to recurring or related tasks. In contrast, the STM captures recent interactions and context, allowing the system 106 to process ongoing tasks effectively and adapt to immediate requirements.

In one or more embodiments, the AI agents stored in the agent repository 214 leverage underlying technologies such as, knowledge base and ontologies which are used to store structured knowledge and define semantic relationships, enabling the AI agents to understand and reason about complex domains. Vector databases are employed to facilitate context-aware retrieval of information, ensuring that the agents can access and utilize relevant data efficiently. LLMs and Small Language Models (SLMs) are utilized for AI-driven decision-making, allowing the AI agents to process natural language inputs and generate intelligent responses tailored to user needs. Additionally, the repository includes an API store that enables seamless integration with third-party services or tools through standardized APIs, expanding the agents’ capabilities and supporting diverse application requirements.

### Exemplary Embodiment

Consider an exemplary scenario in the insurance claims domain, where a customer initiates a First Notice of Loss (FNOL) interaction through a conversational interface by providing the following natural language query: "I was in an accident and want to file a claim for my vehicle damage. Can you assist me?"

The query processing module 208 breaks down the input query received from the customer into logical sub-tasks:

Parse and extract the intent and relevant entities from the query.

Validate query semantics to ensure alignment with the system's supported operations.

Transform the query into a structured format that can guide downstream processing.

### Sub-Tasks:

Parse the query using NLP to extract critical entities:

Intent: "File a claim."

Incident type: "Vehicle damage."

Context: "Accident."

Reframe the query into a machine-readable structure: "Initiate FNOL process for a vehicle damage claim caused by an accident."

The identification module 210 identifies the required data sources and workflows needed to fulfill the query.

### Sub-Tasks:

Consult metadata catalogs to identify relevant data sources, such as:

Policy Database: Contains customer policy details.

Incident History Repository: Stores prior claims data.

Vehicle Damage Assessment Data: Maintains models for damage estimation.

Generate a dependency map of required datasets and workflows, such as:

Validating policy coverage.

Collecting incident details.

Initiating damage assessment.

The pattern module 212 applies reusable process templates to handle the FNOL workflow efficiently.

### Sub-Tasks:

Identify reusable patterns, such as:

Policy Validation: Ensure the policy is active and covers vehicle damage.

Damage Reporting: Record incident details and images from the customer.

Estimation Workflow: Use AI models to estimate repair costs.

Define intermediate operations using these patterns:

Step 1: Validate policy details.

Step 2: Capture and log incident details.

Step 3: Generate a preliminary damage estimate.

The agent repository 214 assigns specific agents to execute each sub-task.

### Sub-Tasks:

Retrieve relevant agents from the repository, such as:

Policy Validation Agent: To confirm policy coverage and eligibility.

Incident Data Capture Agent: To collect and verify incident details and media.

Damage Estimation Agent: To apply ML-based damage assessment models.

Map agents to sub-tasks:

Agent 1 handles policy validation.

Agent 2 captures incident data.

Agent 3 performs damage estimation.

The matching module 216 matches sub-tasks to agents and computational frameworks.

### Sub-Tasks:

Match policy validation tasks to the Policy Validation Agent.

Assign incident data collection to the Incident Data Capture Agent.

Allocate damage estimation to the Damage Estimation Agent.

The framework repository 218 provides the required orchestration frameworks for each sub-task.

### Sub-Tasks:

Select rule-based frameworks for policy validation tasks.

Use image-processing frameworks for analyzing uploaded photos of the damaged vehicle.

Employ ML-based frameworks for estimating repair costs.

The selection module 220 selects the optimal frameworks and agents for execution.

### Sub-Tasks:

Analyze the nature of the sub-tasks (e.g., policy validation, image processing, damage estimation).

Match sub-task characteristics with suitable frameworks based on capabilities such as:

Handling structured versus unstructured data.

Supporting multi-modal inputs (e.g., text, images).

Managing feedback loops for iterative assessment and refinement.

The execution module 222 executes sub-tasks in a structured workflow and compiles the results.

### Sub-Tasks:

Validate policy details to confirm claim eligibility.

Log incident details, including textual descriptions and uploaded images.

Analyze the damage using an ML model to estimate repair costs and recommend next steps.

### Output:

The system 106 provides the following results to the user:

Policy Validation: "Your policy is active and covers vehicle damage claims."

Damage Estimate: "Estimated repair cost is $3,000. The nearest authorized repair center is 2 miles away."

Next Steps: "Would you like to schedule an appointment for repairs or file the claim now?"

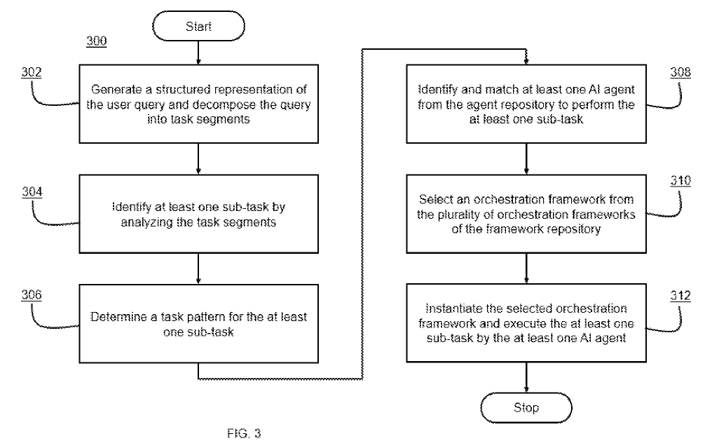

FIG. 3 is a diagram that illustrates a flowchart 300 with a method for orchestrating AI agents using an agentic AI platform, in accordance with an embodiment of the disclosure.

The UI 102 may be configured to receive user queries in one or more formats such as, text, voice, or structured input (e.g., forms or dropdown menus).

At 302, upon receiving the user query via the UI 102, the query processing module 208 generates a structured representation of the query. The query processing module 208 utilizes a natural language model that is capable of understanding and interpreting the query for generating the structured representation.

In one or more embodiments, the query processing module 208 first analyzes the query to detect key components such as the intent, entities, and relationships within the user’s request, and converts the information into a structured format, such as a query template, that can be easily processed by the system 106.

In one or more embodiments, the query processing module 208 decomposes the structured representation of the query into at least one task segment using the LLM. The LLM analyzes the structured query representation to break it down into smaller, more manageable components, each corresponding to a distinct task or sub-task. The task segments are defined based on the identified objectives and constraints, enabling the system 106 to handle complex, multi-step processes. The LLM understands the context and relationships within the query so that each segment accurately represents a portion of the user's intent.

At 304, at least one sub-task within the task segment is identified by the identification module 210. Upon receiving the task segment, the identification module 210 analyzes its content and context to break it down into smaller, more specific sub-tasks. The sub-tasks are typically more granular actions or objectives that contribute to fulfilling the task segment. The identification module 210 leverages domain knowledge, predefined rules, and contextual information to ensure accurate identification of sub-tasks.

At 306, the pattern module 212 determines a task pattern for the at least one sub-task by analyzing task dependencies and execution flow. Upon receiving the identified sub-task, the pattern module 212 examines the interdependencies between various sub-tasks, taking into account factors such as sequential, parallel, or conditional execution requirements. The pattern module 212 then analyzes the flow of execution, ensuring that the tasks are processed in an efficient order based on their dependencies, priority, and available resources.

In one or more embodiments, the pattern module 212 is configured to dynamically adapt the task processing pattern based on real-time conditions, such as resource availability or external events, which may affect the execution flow. The adaptability allows the system 106 to adjust its task processing approach in response to changing workloads, so that the task completion is efficient and aligned with the overall goals.

At 308, the matching module 216 identifies and matches at least one AI agent of the plurality of AI agents from the agent repository 212, to perform the at least one sub-task. In cases where multiple sub-tasks are identified, the matching process by the matching module 216 is performed iteratively. Each sub-task is analyzed either sequentially or in parallel, by examining its objectives, constraints, and dependencies. The iterative analysis enables the matching module 216 to evaluate the specific requirements of each sub-task and compare them against the capabilities, specialties, and configurations of the available AI agents in the agent repository 214. By performing the iterative matching process, the system 106 selects the most appropriate AI for each sub-task, thereby optimizing task execution and ensuring alignment with the overall task processing pattern. .

In one or more embodiments, the matching module 216 evaluates the functionality of each AI agent, determining which agent is best suited to handle the particular sub-task, which may involve matching domain expertise, computational capabilities, and available tools or APIs. For instance, if the sub-task involves natural language processing, the matching module 216 might select an AI agent specialized in NLP tasks. Similarly, if the sub-task requires data analysis or machine learning, the matching module 216 may match the appropriate AI agent with the necessary algorithms and data-processing tools.

At 310, the selection module 220 selects an orchestration framework from the plurality of orchestration frameworks of the framework repository 218.

In one or more embodiments, the selection module 220 analyzes the structured representation of the user query and the identified task processing patterns to determine the most suitable orchestration framework.

In one or more embodiments, the selection module 220 selects an orchestration framework based on parameters comprising the task processing pattern and characteristics of the at least one sub-task.

In one or more embodiments, the task processing pattern refers to the structural approach required for executing the sub-task, such as sequential processing, parallel processing, iterative processing, or graph-based processing. The selection module 220 evaluates the task dependencies, execution flow, and resource allocation needs to match the processing pattern with a compatible orchestration framework.

In one or more embodiments, selecting the orchestration framework by the selection module 220 involves matching capabilities of each orchestration framework with the task requirements. The capabilities of each orchestration framework are derived from the metadata maintained within the framework repository 218. The metadata provides detailed descriptions of the frameworks, including their supported task processing patterns (e.g., sequential, parallel, iterative, graph-based), resource utilization efficiency, scalability, compatibility with AI agents, and domain-specific optimizations. The selection process emphasizes pattern detection at the task level for effective agent orchestration and considers the specific nature of the task. The nature of the task may include:

Iterative or feedback loop feature, where tasks require repeated refinement or cyclical evaluation;

Decision-making capability, to determine whether intelligent decisions are required at various stages;

Multi-modal capabilities, to handle tasks involving diverse data types or input formats;

Human intervention capability, to allow for manual oversight or input when needed;

Multi-agent collaboration patterns, to support complex interactions and coordinated execution among multiple agents.

At 312, the execution module instantiates the selected orchestration framework from the framework repository 218. Upon instantiating the selected orchestration framework, the execution module 222 executes the at least one sub-task by leveraging the capabilities of the at least one AI agent identified by the matching module 216. Each agent execution comprises three iterative steps such as, Observation, Action, and Reflection.

Observation may involve analyzing the sub-task context, including its objectives, current state, and any dependencies, to gather the necessary input for execution.

Action may refer to the execution of the sub-task by the agent, as defined by the orchestration framework and its task processing flow.

Reflection may involve evaluating the outcomes of the executed action, identifying changes in the task context, and generating observations for subsequent steps.

In an exemplary embodiment, if the selected orchestration framework supports parallel processing, the execution module 222 coordinates the simultaneous execution of multiple sub-tasks by distributing them across compatible AI agents. Alternatively, for sequential processing, the execution module 222 ensures that the sub-tasks are executed in the correct order, with the output of one serving as the input for the next. In the case of iterative processing, the execution module 222 manages repeated cycles of execution to refine results or meet specific task criteria.

The described method and system provides significant advantages over conventional solutions by offering the capability to dynamically select and integrate functionalities from multiple orchestration frameworks, which ensures seamless adaptability to varying task requirements by leveraging the most appropriate orchestration frameworks or tools available in the ecosystem.

An additional transformative feature of the method and system lies in its ability to facilitate the on-the-fly creation of workflows, which allows users to quickly select AI agents tailored to specific tasks, without requiring extensive manual coding efforts. The inclusion of low-code/no-code flexibility empowers non-technical users to construct workflows and define agent behaviors through intuitive graphical interfaces, templates, or natural language commands, thereby democratizing access to advanced AI capabilities.

The method and system further enhance versatility and effectiveness by enabling seamless integration with third-party tools and APIs, which allows the system to leverage external domain-specific capabilities, comprehensive knowledge bases, and a wide range of cognitive constructs, extending its functionality beyond the native ecosystem.

Advantageously, by connecting to third-party tools, the system can access specialized capabilities tailored to specific industries or tasks, such as advanced analytics platforms, proprietary data repositories, or domain-specific algorithms.

The method and system is further enhanced by their support for multi-modal LLM capabilities, enabling them to address a diverse array of tasks and seamlessly integrate various data modalities. The multi-modal functionality allows the system to process and analyze heterogeneous data types such as text, images, audio, video, and structured data, significantly expanding its application potential across industries.

The method and system offer significant advantages by freeing users from vendor lock-in, allowing them to seamlessly access and integrate best-in-class capabilities from a wide range of AI and agent orchestration frameworks. This flexibility is a critical feature for organizations that seek to maximize the effectiveness of their systems while avoiding the limitations typically imposed by single-vendor solutions. Users can select the most suitable agents, models, and tools from different vendors or frameworks based on specific requirements, without being constrained by proprietary technologies or rigid ecosystems.

The method and system provides sophisticated agentic AI capabilities, which include advanced memory management, cognitive constructs, and persistent stores to enhance the decision-making and task execution processes, which enable agents within the system to exhibit higher levels of intelligence, adaptability, and long-term functionality, making them more efficient and effective in complex environments.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. An agentic artificial intelligence system, comprising:
at least one processor;
a memory storing instructions;
a framework repository comprising a plurality of orchestration frameworks;
an agent repository comprising a plurality of artificial intelligence agents, wherein each agent is configured to perform specialized tasks; and wherein the instructions, when executed, cause the at least one processor to
receive a user query;
generate a structured representation of the query using a natural language model;
decompose the structured representation into at least one task segment;
for each task segment:
identify at least one sub-task within the task segment;
determine a task processing pattern for the at least one sub-task by analyzing task dependencies and execution flow;
identify at least one artificial intelligence agents of the plurality of artificial intelligence agents for performing the at least one sub-task;
select an orchestration framework from the framework repository based on parameters comprising the task processing pattern and characteristics of the at least one sub-task;
instantiate the orchestration framework; and
execute the at least one sub-task using the at least one artificial intelligence agent through the orchestration framework.

2. The system of claim 1, wherein the task processing pattern comprises at least one of a sequential processing, a parallel processing, an iterative processing, and a graph based processing.

3. The system of claim 1, wherein the framework repository (218) maintains metadata for each orchestration framework indicating supported task processing patterns.

4. The system of claim 1, wherein selecting the orchestration framework comprises matching capabilities of each orchestration framework with the task requirements.

5. The system of claim 1, wherein the structured representation comprises task objectives and constraints.

6. A method of orchestrating artificial intelligence agents, comprising:
receiving a user query;
generating a structured representation of the query using a natural language model;
decomposing the structured representation into at least one task segment;
for each task segment:
identifying at least one sub-task within the task segment;
determining a task processing pattern for the at least one sub-task by analyzing task dependencies and execution flow;
identifying at least one artificial intelligence agent of a plurality of agents stored in an agent repository for performing the at least one sub-task;
selecting an orchestration framework from a framework repository based on parameters comprising the task processing pattern and characteristics of the at least one sub-task;
instantiating the orchestration framework; and
executing the at least one sub-task using the at least one artificial intelligence agent through the orchestration framework.

7. The method of claim 6, wherein the task processing pattern comprises at least one of a sequential processing, a parallel processing, an iterative processing, and a graph-based processing.

8. The method of claim 6, wherein the framework repository maintains metadata for each orchestration framework indicating supported task processing patterns.

9. The method of claim 6, wherein selecting the orchestration framework comprises matching framework capabilities with the task requirements.
